(19) United States
(12) Patent Application Publication
(10) Pub. No.: US 2019/0335673 A1
(43) Pub. Date: Nov. 7, 2019

(54) APPARATUS AND METHOD FOR LAND CLEARING AND PREPARATION

(71) Applicant: Fecon, Inc., Lebanon, OH (US)

(72) Inventors: Jeffrey T. Stanley, Lebanon, OH (US); Steven K. Watson, Lebanon, OH (US)

(21) Appl. No.: 16/400,741

(22) Filed: May 1, 2019

Related U.S. Application Data
(60) Provisional application No. 62/665,215, filed on May 1, 2018.

(51) Int. Cl. A01G 3/00; B02C 18/18

(52) U.S. Cl. CPC A01G 3/002; B02C 18/18

(57) ABSTRACT

A land preparation tool. The land preparation tool can include a tool body, and the tool body can include a cutting surface, a mounting interface disposed along a side of the body opposite the cutting surface, a first angled surface that sweeps backward from the cutting surface toward the mounting interface, and a second angled surface that is disposed on a side of the cutting surface opposite the first angled surface and sweeps backward from the cutting surface toward the mounting interface. The tool can also include a blade disposed on the same side of the tool body as the cutting surface and a channel disposed into the mounting interface and extending into the tool body. The mounting interface can include a nonplanar profile.

### BACKGROUND

The present disclosure relates to attachment systems and methods for land preparation tools, such as cutting, grinding, mulching, and/or shredding tools, and more particularly tool interfaces for attachments to powered vehicles.

Land preparation and clearing machines and apparatus such as forestry machines and apparatus are utilized for clearing land, creating paths, and otherwise removing debris, brush, trees, vegetation, soil, concrete, asphalt, rock, and/or other materials, making the land suitable for further development or use. To carry out these tasks, such machines can be fitted with land preparation attachments or apparatus operable to mulch, cut, shred, and/or grind vegetation, brush, trees, stumps, soil, concrete, asphalt, rock, and other materials.

In particular, the apparatus may be integrally or detachably attached to a tractor, skid steer, or other vehicle to facilitate articulation and movement of the mowing apparatus with respect to the vegetation. Often, the vehicle is a multi-purpose vehicle having the capability to be fitted with any of a variety of attachments suitable for the task at hand. For example, the vehicle can include a common connection for connecting to and driving the apparatus such as brush cutters, rotary mowers, shredders, grinders, and crushers. Such land preparation and clearing apparatus can be hydraulically driven via hydraulic power from the vehicle. One illustrative type of land preparation and clearing apparatus is known as a “flail mower” which utilizes a rotatable axle with either swinging or fixed position cutting tools (often known as “flails”).

### SUMMARY

According to an embodiment, a land preparation apparatus comprising a rotatable drum and a plurality of tool assemblies disposed on the rotatable drum is provided. Each tool assembly comprises a tool holder comprising a mounting surface defining a non-planar profile, and a land preparation tool connected to the tool holder and comprising a mounting surface in flush contact with the tool holder mounting surface. The mounting surface of the land preparation tool defines a non-planar profile which is the inverse of the non-planar profile of the tool holder mounting surface.

The embodiments of the disclosure will be more fully understood in view of the following detailed description, in conjunction with the drawings.

### BRIEF DESCRIPTION OF THE DRAWINGS

The following detailed description of embodiments can be best understood when read in conjunction with the drawings enclosed herewith:

FIG. 1 is a top isometric view of an illustrative land preparation and clearing machine according to one or more embodiments;

FIG. 2 is a isometric view of the illustrative land preparation and clearing machine of FIG. 1;

FIG. 3A is a front elevational view of an illustrative land preparation apparatus according to one or more embodiments;

FIG. 3B is a cutaway exploded view of an illustrative rotatable tool showing the coupling arrangement of the illustrative tool assembly of FIG. 4A to the rotatable drum of FIG. 3A according to one or more embodiments;

FIG. 4A is an exploded isometric view of an illustrative tool assembly comprising a tool holder, and a land preparation tool according to one or more embodiments;

FIG. 4B is a rotated, exploded isometric view of the illustrative land preparation tool of FIG. 4A which shows the mounting surface of the illustrative land preparation tool according to one or more embodiments;

FIG. 5A is an exploded isometric view of another illustrative tool assembly comprising a tool holder, and a land preparation tool according to one or more embodiments;

FIG. 5B is a rotated, exploded isometric view of the illustrative land preparation tool of FIG. 5A which shows the mounting surface of the illustrative land preparation tool according to one or more embodiments;

FIG. 6A is an exploded isometric view of yet another illustrative tool assembly comprising a tool holder, and a land preparation tool according to one or more embodiments;

FIG. 6B is a rotated, exploded isometric view of the illustrative land preparation tool of FIG. 6A which shows the mounting surface of the illustrative land preparation tool according to one or more embodiments;

FIG. 7A is an exploded isometric view of yet another illustrative tool assembly comprising a tool holder, and a land preparation tool comprising pairs of upper and lower cutting blades according to one or more embodiments;

FIG. 7B is a rotated, exploded isometric view of the illustrative tool assembly of FIG. 7A according to one or more embodiments;

FIG. 8A is an exploded isometric view of another illustrative tool assembly according to one or more embodiments;

FIG. 8B is a rotated, exploded isometric view of the illustrative tool assembly of FIG. 8A according to one or more embodiments;

FIG. 9A is an exploded isometric view of an illustrative tool assembly comprising a tool holder, an intermediate connector, and a land preparation tool according to one or more embodiments;

FIG. 9B is a rotated, exploded isometric view of the illustrative intermediate connector of FIG.9A which shows the mounting surface of the illustrative land preparation tool according to one or more embodiments;

FIG. 10A is an exploded isometric view of an illustrative tool assembly comprising a tool holder, an intermediate connector, and a land preparation tool according to one or more embodiments;

FIG. 10B is a rotated, exploded isometric view of the illustrative intermediate connector of FIG. 10A which shows the mounting surface of the illustrative land preparation tool according to one or more embodiments;

FIG. 11A is an exploded isometric view of an illustrative tool assembly comprising a tool holder, an intermediate connector, and a land preparation tool comprising a plurality of blades according to one or more embodiments;

FIG. 11B is a rotated, exploded isometric view of the illustrative intermediate connector of FIG. 11A which shows the mounting surface of the illustrative land preparation tool according to one or more embodiments;

FIG. 12A is a front view of an illustrative land preparation tool comprising a cutting surface with an outwardly extending lower region according to one or more embodiments;

FIG. 12B is a isometric view of the illustrative land preparation tool of FIG. 12A according to one or more embodiments;

FIG. 13A is a front view of another illustrative land preparation tool comprising a cutting surface with an outwardly extending lower region and side surfaces with outwardly extending lower regions according to one or more embodiments;

FIG. 13B is a isometric view of the illustrative land preparation tool of FIG. 13A according to one or more embodiments;

FIG. 14A is a front isometric view of an illustrative land preparation tool according to one or more embodiments;

FIG. 14B is a rear isometric view of the illustrative land preparation tool of FIG. 14A according to one or more embodiments;

FIG. 14C is a right side view of the illustrative land preparation tool of FIG. 14A according to one or more embodiments;

FIG. 14D is a left side view of the illustrative land preparation tool of FIG. 14A according to one or more embodiments;

FIG. 14E is a top view of the illustrative land preparation tool of FIG. 14A according to one or more embodiments;

FIG. 14F is a bottom view of the illustrative land preparation tool of FIG. 14A according to one or more embodiments;

FIG. 14G is a front view of the illustrative land preparation tool of FIG. 14A according to one or more embodiments;

FIG. 14H is a cross sectional view of the illustrative land preparation tool of FIG. 14A, taken along line N-N;

FIG. 14I is a back view of the illustrative land preparation tool of FIG. 14A according to one or more embodiments;

FIG. 14J is a cross sectional view of an alternative embodiment of the land preparation tool of FIG. 14A; and

FIG. 15 is a side view of an illustrative rotatable tool according to one or more embodiments.

The embodiments set forth in the drawings are illustrative in nature and not intended to be limiting of the invention defined by the claims. Moreover, individual features of the drawings and the disclosure will be more fully apparent and understood in view of the detailed description.

### DETAILED DESCRIPTION

The present disclosure is generally directed to land preparation and clearing machines (“land preparation machines”) that are designed to cut, grind, mulch, shred, clear, mill, and/or mix trees, brush, ground cover, vegetation, debris, asphalt, concrete, and/or soil. The land preparation machines and their corresponding implements may comprise a variety of vehicles and implements, including but not limited to skid steer vehicles, forestry machines and vehicles, PTO tractors, farm tractors and/or any other known vehicles and their corresponding implements compatible with land preparation and clearing. Such land preparation machines may prepare the surface and subsurface of the earth. As used herein, the phrases “land preparation and clearing” and “land preparation” will mean any land preparation and clearing operations, including but not limited to forestry operations such as cutting, grinding, mulching, shredding, clearing, milling, and/or mixing trees, brush, ground cover, vegetation, debris, soil, rock, asphalt, concrete, and/or soil. As used herein, “feed material” describes trees, brush, ground cover, vegetation, debris, soil, rock, asphalt, concrete, and/or soil produced from such land preparation and clearing operations, including but not limited to forestry operations such as clearing land, cutting and/or mulching trees, and/or preparing land surfaces (e.g., creating paths).

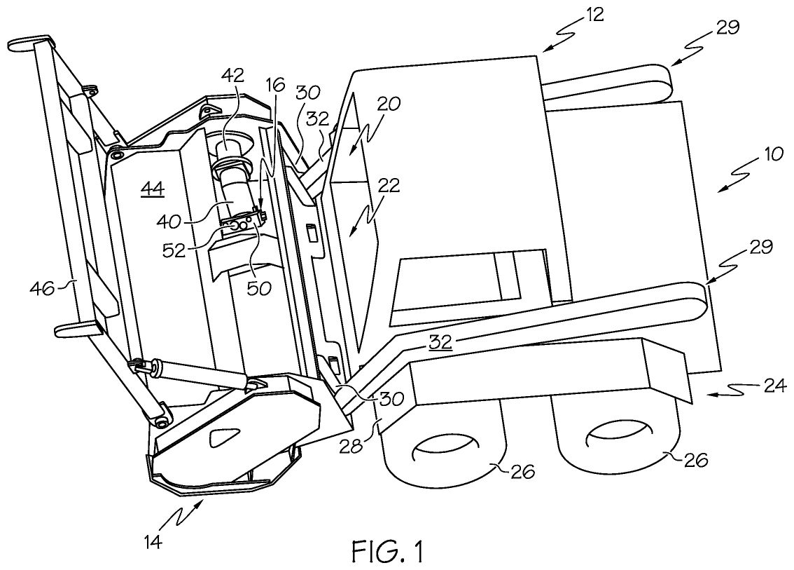

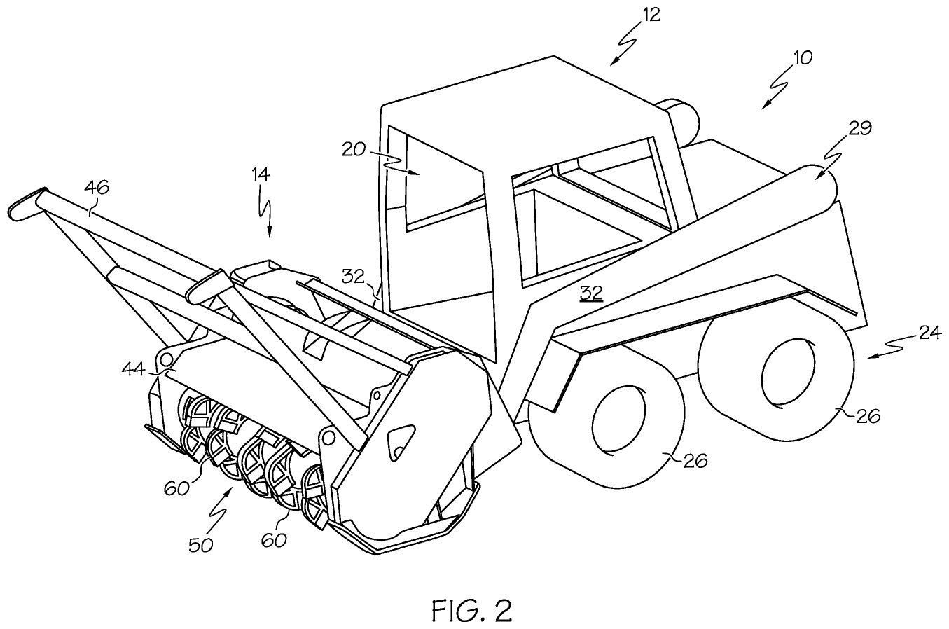

Referring to FIGS. 1-2, an illustrative embodiment of a land preparation machine 10 includes a vehicle 12 (e.g., a forestry vehicle) and a land preparation apparatus 14 connected to the vehicle 12. In this illustrative embodiment, the vehicle 12 is a skid steer vehicle suitable for off-road travel, and includes a driver station 20 as well as an all-terrain wheel assembly 24. The wheel assembly 24 may include tires 26. In addition, tires 26 may drive all-terrain tracks (not shown), which may provide traction for the vehicle 12 to move over a variety of terrains and in a variety of conditions. The all-terrain tracks may comprise metal or rubber-based tracks that wrap around tires 26 as known to one of ordinary skill in the art. The vehicle 12 also includes a hydraulically operated vertical lift assembly 29 for vertically lifting the land preparation apparatus 14, and any other attachments that may be used with the vehicle. Controls 22 can be provided for control of the hydraulic lift assembly 29, including the lift arms 32 as well as for controlling the power provided to the wheel assembly 24 and for controlling the operation of the land preparation apparatus 14.

While the land preparation apparatus 14 is shown in this example connected to and powered by vehicle 12 which is a skid steer vehicle, other suitable all-terrain vehicles with capability for powering and utilizing a hydraulic motor attachment or tool (e.g., such as land preparation apparatus 14) could be provided, such as other forestry vehicles, mini-track loaders, excavators, backhoes, PTO tractors, farm tractors, and/or any other known vehicles and their corresponding implements compatible with land preparation and clearing. Further examples of suitable skid steer vehicles are shown and described in U.S. Pat. Nos. 4,168,757 and 4,209,071, the entire disclosures of which are hereby incorporated by reference herein.

In the illustrative embodiment shown in FIGS. 1 and 2, the land preparation apparatus 14 is removably connectable to the vehicle 12. The connection between the land preparation apparatus 14 (or any other attachment) and the vehicle 12 can be accomplished in any of a variety of manners, such as by providing receptacles 30 for receiving vertical lift arms 32 from the vehicle 12. The land preparation apparatus 14, in this example, further includes a hydraulic supply connection for receiving an operating supply of hydraulic fluid from a pump within the vehicle to power the land preparation apparatus 14, and a hydraulic return connection for returning hydraulic fluid to a tank within the vehicle 12. The hydraulic supply and return connections may comprise convention quick-disconnect connections as known to one of ordinary skill in the art.

It is understood that land preparation apparatus 14 may also be fixedly attached to the vehicle 12 and/or be a stand-alone machine such as a walk behind land preparation apparatus. Also, it is understood that other hydraulically-operated rotary mowing or cutting attachments may be utilized with principles of one or more of the embodiments shown and described herein, integral with or detachable from vehicle 12, and/or separately from or in combination with the land preparation apparatus 14. Other configurations are also possible, such as where the fluid pump and tank are located at other locations. Connection, powering, and movement of the land preparation apparatus 14 can be accomplished with various configurations, such as those described in U.S. Pat. Nos. 4,148,366, and 5,813,792, for example, which are hereby incorporated herein by reference.

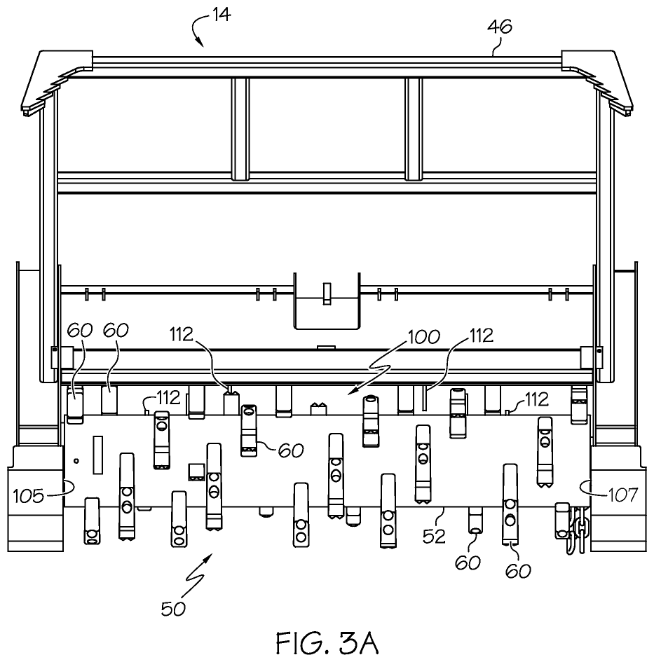

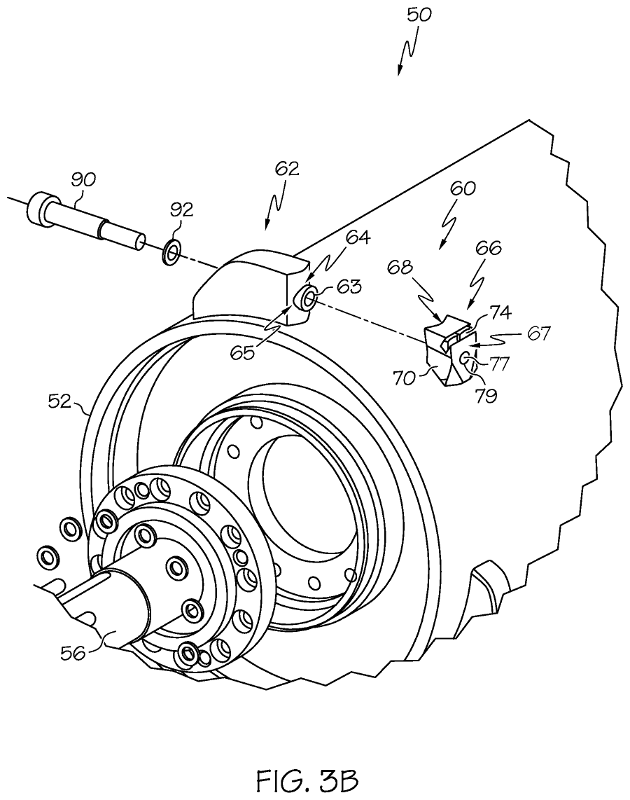

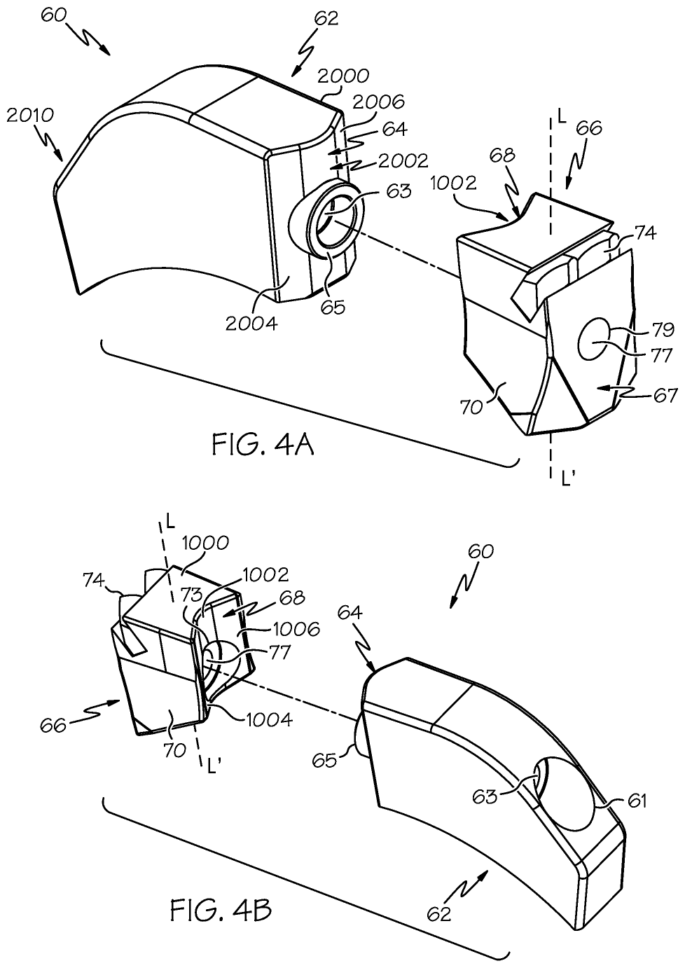

Referring to FIGS. 1-3A, the land preparation apparatus 14 may include a housing 44 forming a chamber 100, right and left end plates 105 and 107, respectively, connected to the housing 44, and a movable tool (e.g., rotatable tool 50) movably (e.g., rotatably) connected to and between the right and left end plates 105 and 107 within the chamber 100. Right and left end plates 105 and 107 may alternatively be integral with the housing 44. In this illustrative embodiment, the rotatable tool 50 comprises a rotatable drum 52 or rod and a plurality of tool assemblies 60 spaced along and extending radially from the tool drum 52 as shown in FIGS. 2 and 3A. For additional details regarding the arrangement of tool assemblies 60 on the rotatable drum, U.S. Publication No. 2009/0050341 A1 has been incorporated by reference herein in its entirety. FIGS. 4A-14B shows multiple illustrative embodiments of tool assemblies 60 in accordance with one or more embodiments.

Optionally, rotatable tool 50 may also comprise an axle 56 extending longitudinally from either one or both ends of the tool drum 52. For movement of the rotatable tool 50, a hydraulic motor 40, such as a hydraulic piston motor, provides rotation of a rotor (e.g., drive shaft 42) which drives the rotatable tool drum 52, which thereby causes rapid rotation of the tool assemblies 60, such as at speeds of between about 100 to about 3000 rpm. The drive shaft 42 may drive a belt (not shown), which engages and drives the axle 56 to turn tool drum 52. Alternatively, the drive shaft 42 may be directly connected to the drum 52 or axle 56.

In one particular embodiment, the hydraulic lift arms 32 raise and lower the land preparation apparatus 14 via controls 22 to allow the tool assembly 60 (e.g., the teeth or cutters of the tool assembly 60) to come into contact with brush, trees, vegetation, or other objects to be cut or shredded or cleared. Controls 22 may also control the supply of fluid to the hydraulic motor 40 to start and stop the rotation of the tool drum 52 and tool assemblies 60. The land preparation apparatus 14 may include any number of suitable components, cutters, grinders, mixers, and/or tools for providing a cutting, grinding, mulching, shredding, clearing, milling, and/or mixing function. In addition, the land preparation apparatus may comprise safety mechanisms such as a guard assembly 46 as shown in FIGS. 1-3A.

In yet another illustrative embodiment, the hydraulic motor 40 is controlled by a hydraulic brake 16 which automatically slows the motor 40 when the flow of hydraulic fluid to the motor via the hydraulic supply line is discontinued. For additional detail on land preparation machinery (e.g., forestry machinery) or hydraulic components associated with land preparation machinery (e.g., forestry machinery), U.S. Publication No. 2006/0032222 has been incorporated by reference in its entirety herein.

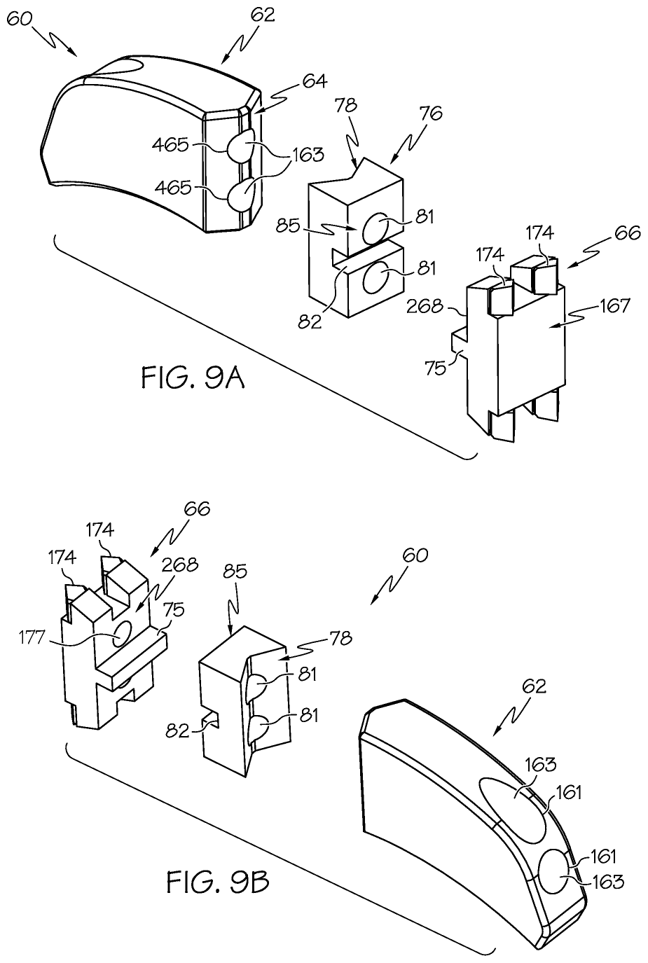

Referring to the embodiments of FIGS. 3B-11B, each tool assembly 60 comprises a tool holder 62 and a land preparation tool 66. As will be described herein in view of the figures, the term “land preparation tool” includes, but is not limited to a cutter, blade, grinder, chipper, knife, hammer tool, milling tool, flailing tool or element, carbide tip, steel tip, composite tip, any other tool for suitable for land surface preparation and clearing as described and defined above herein, or any combination thereof. The tool assemblies 60, and any of its components, may be fabricated from a variety of metals, composites, plastics, or combinations thereof. Additional detail regarding tool assemblies is provided in U.S. Pat. No. 4,223,441 and U.S. Pat. No. 4,222,418, which are hereby incorporated by reference herein. Further as will be described herein in view of the figures, the term “tool holder” is a support structure for the land preparation tool. The land preparation tool 66 may be directly connected to the tool holder 62 as shown in FIGS. 4A-8A or may be connected to the tool holder 62 via an intermediate connector 76 as will be described in detail below and shown in FIGS. 9A-11B. As used herein, “connected” may mean fixedly connected (for example, by welding together the tool holder 62, the land preparation tool 66, and optionally the intermediate connector 76) or removably connected (for example, by bolting, matingly coupling, adhering, or magnetically coupling the tool holder 62, the land preparation tool 66, and optionally the intermediate connector 76). If removable, the land preparation tool 66 may comprise a replaceable tip that is designed to be replaced once worn due to use, permitting the tool holder 62 to remain affixed to the tool drum 52 while the tool 66 is replaced.

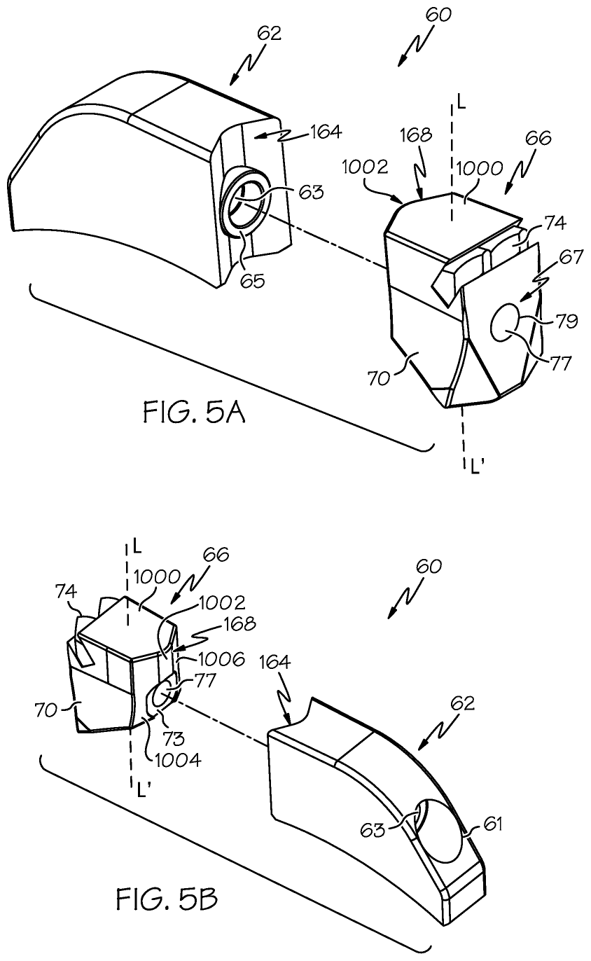

Referring to the embodiment of FIGS. 4A and 4B, the tool holder 62 comprises a mounting surface 64 defining a non-planar profile. As used herein, non-planar profile defines any surface, which is not a straight planar surface, for example, V-shaped, concave, convex, or combinations thereof. As shown in the embodiment of FIG. 4A, the non-planar profile of the tool holder mounting surface 64 may define a convex V-shape, wherein the mounting surface 64 tapers outwardly towards the middle of the tool holder mounting surface 64. Referring to an alternative embodiment as shown in FIG. 5A, the non-planar profile of the tool holder mounting surface 164 may define a concave V-shape, wherein the mounting surface 164 tapers inwardly towards the middle of the tool holder mounting surface 164.

Referring to FIGS. 4A and 4B, each land preparation tool 66 may also comprise a mounting surface 68, which defines a non-planar profile which is the inverse of the non-planar profile of the tool holder mounting surface 64. As shown in FIG. 4B, the mounting surface 68 of the land preparation tool 66 may define a concave V-shape, which is the inverse of the convex V-shape configuration of the tool holder mounting surface 64. In an alternative embodiment as shown in FIG. 5B, the mounting surface 168 of the land preparation tool 66 defines a convex V-shape, which is the inverse of the concave V-shape configuration of the tool holder mounting surface 164. As a result of the inverse non-planar profiles of the mounting surfaces, flush contact may be achieved when the tool holder 62 and land preparation tool 66 are connected. This yields an interference fit or a friction fit between the inverse surfaces 64 and 68, which combats sliding (e.g., horizontal sliding) of the tool holder 62 or land preparation tool 66.

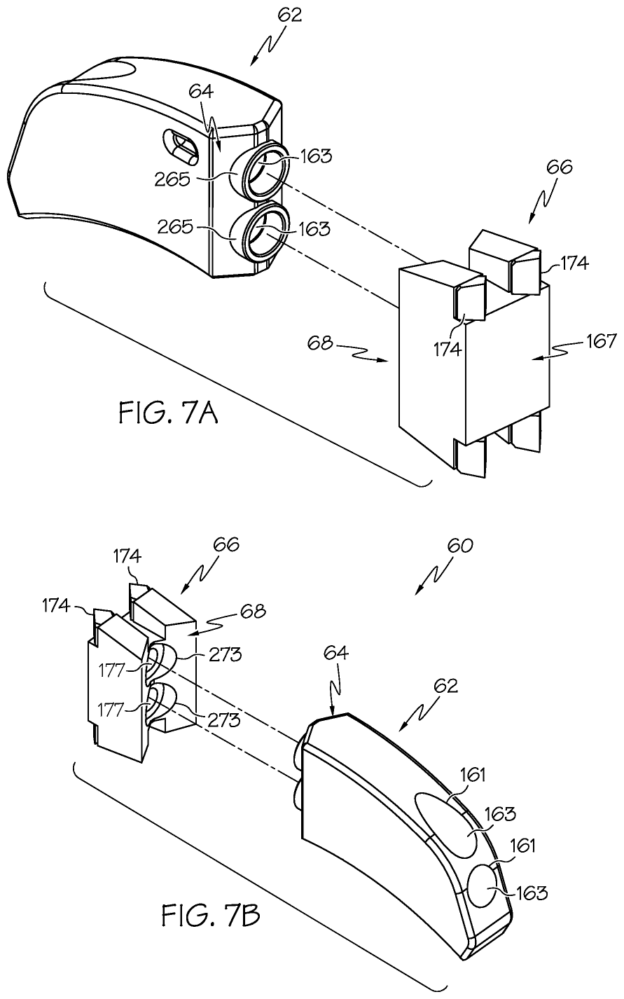

In addition to the interference fit between inverse surfaces 64 and 68, other coupling arrangements are further contemplated. Referring again to FIGS. 4A and 4B, each tool holder 62 may comprise a coupling mechanism 65 disposed on the mounting surface 64 of the tool holder 62. As shown in the embodiment of FIGS. 4A and 4B, the coupling mechanism may comprise at least one rounded bushing or peg 65 extending from the mounting surface 64 of the tool holder 62. The rounded peg 65 of FIGS. 4A and 4B may be hollow with a channel 63 therein, wherein the channel 63 extends from the rounded peg 65 to an opening 61 disposed on the opposite end of the tool holder 62. While FIGS. 4A and 4B depict only one channel 63 extending through the tool holder 62, it is contemplated to have more than one channel. In the illustrative embodiment of FIGS. 7A and 7B, the tool holder 62 comprises a pair of rounded pegs 265 with a pair of rounded channels 163 disposed therein. As shown in FIG. 7A and 7B, the one peg is disposed above the other peg; however, a side-by-side configuration of rounded pegs (not shown) is also contemplated herein.

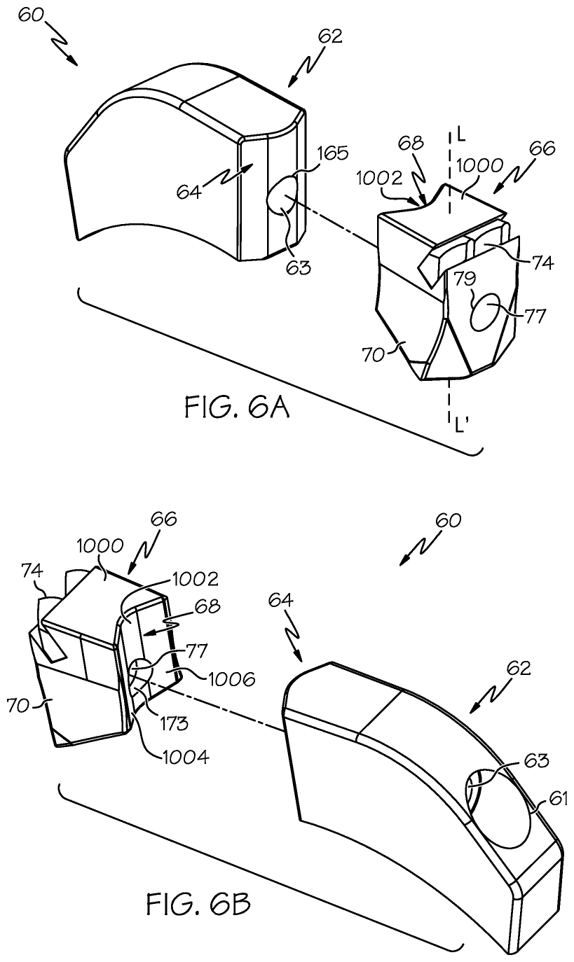

In yet another embodiment as shown in FIGS. 6A-6B, the tool holder 62 may lack a rounded peg or comparable coupling mechanism on the mounting surface 64; however, the tool holder 62 may still include a channel 63 extending from opening 165 on the mounting surface 64 to opening 61 disposed on the opposite end of the tool holder 62. The FIG. 9A and 9B embodiments also lack a coupling mechanism but include two channels 163 extending from openings 465 on the mounting surface 64 to openings 161 disposed on the opposite end of the tool holder 62. Moreover, the opposite mating arrangement to the illustrative embodiments of FIGS. 4A-5B, and 7A-7B is contemplated. For example, the tool holder 62 may comprise at least one round recess and the land preparation tool 66 may comprise at least one round peg which may be matingly inserted into the round recess of the tool holder 62. Although the present embodiments depict rounded pegs or rounded recesses, other shapes, for example square or rectangular pegs are also contemplated herein.

Additionally, although the figures generally depict channels 63 and 163 with circular tube shapes, other channel shapes and configurations are contemplated herein. Moreover, the channel 63 may be a threaded channel (not shown) disposed inside hollow pegs 65; however, it is contemplated to use non-hollow pegs without channels extending therethrough.

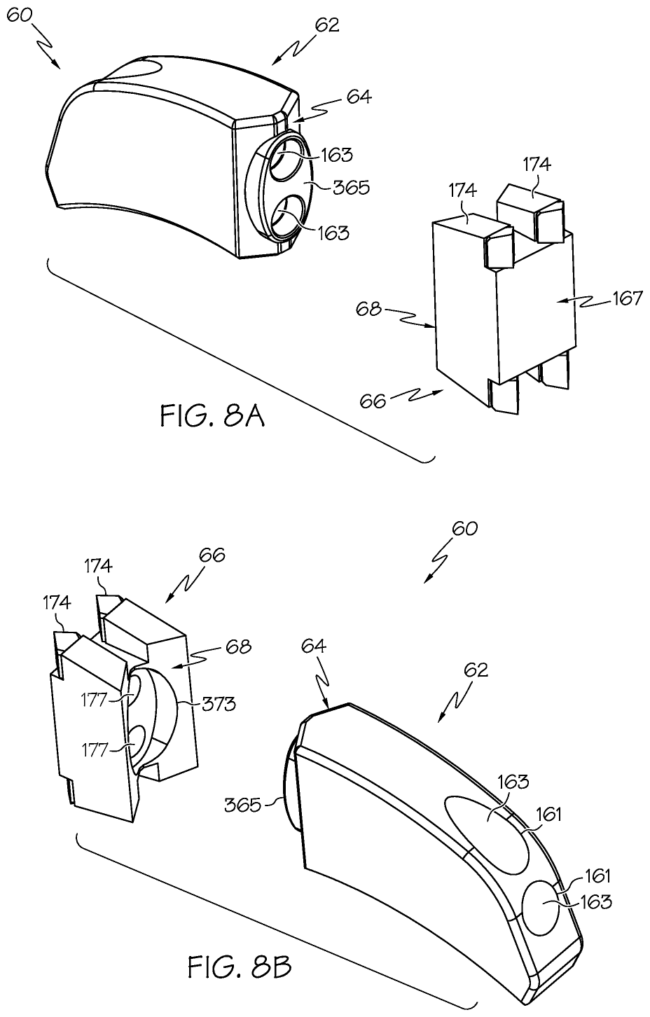

To couple (e.g., matingly couple) with the coupling mechanism of the tool holder 62, the land preparation tool 66 may comprise a coupling mechanism on its mounting surface 68 as shown in FIGS. 4A and 4B. In the embodiment of FIGS. 4A and 4B, the coupling mechanism of the land preparation tool 66 may comprises at least one round recess 73, which may receive the round peg 65 of the tool holder 62, thereby facilitating the mating of the land preparation tool 66 and the tool holder 62. While mating is the depicted coupling arrangement in the figures, other coupling mechanisms for the tool holder 62 and land preparation tool 66 are contemplated herein, for example, welding, adhering, magnetically coupling, or combinations thereof. Further as shown in FIGS. 7A and 7B, the land preparation tool 66 may comprise a pair of rounded recesses 273, which are configured to receive the rounded pegs 265 of the tool holder 62. In yet another embodiment as shown in FIGS. 8A and 8B, the coupling mechanism of the tool holder 62 may also comprise a raising bushing 365 (for example, a raised oval shaped bushing) comprising a pair of orifices therein. For coupling, the land preparation tool 66 comprises a rounded recess 373 (e.g., oval shaped) to correspond to the shape of the raised bushing 365 in order to receive the raised bushing 365 of the tool holder 62.

Moreover as shown in FIGS. 4A and 4B, the land preparation tool 66 may optionally comprise at least one channel 77 extending from the round recess 73 to an opening 79 disposed on the cutting surface 67 of the land preparation tool 66, which is disposed on a surface opposite the mounting surface 68 of the land preparation tool 66. When the tool holder 62 and land preparation tool 66 are coupled, the respective channels 63 and 77 of the tool holder 62 and land preparation tool 66 are aligned. Alternatively, the land preparation tool 66 may also comprise multiple channels such as the two channel 177 embodiment of FIGS. 7A and 7B. In a further embodiment, the channel 77 may be a threaded channel (not shown). The benefits of threaded channels in the tool holder 62 and land preparation tool 66 will be discussed in detail below.

As shown in FIGS. 4A and 4B, the cutting surface 67 may comprise at least one blade, or any other tooling component described above. For example, the cutting surface 67 may comprise twin side-by side blades 74 as shown in FIG. 4B. Alternatively as shown in FIGS. 7A and 7B, the cutting surface 167 may include two pairs of blades 174 disposed on opposite sides of the cutting surface 67. In yet another embodiment as shown in FIG. 11A, the cutting surface 267 may be a quad tooth cutting tool 274. Additional details regarding the cutting surface 67 embodiments of FIGS. 4A-6B and 12A-13B are provided below.

Referring again to the embodiment of FIGS. 3B and 4A, the interference fit of inverse mounting surfaces 64 and 68 in combination with the insertion of rounded peg 65 into rounded recess 73 yields twofold male-female coupling between the tool holder 62 and the land preparation tool 66. To further ensure that the tool holder 62 and the land preparation tool 66 are secured to each other, an additional securing mechanism may also be provided. As shown in FIG. 3B, the rotatable tool 50 may utilize one or more securing bolts 90 extending through the land preparation tool 66, specifically through the tool holder channel 63 and the channel 77 of the land preparation tool 66. For the double channel illustrative embodiment of FIG. 7A, two securing bolts (not shown) may be used to secure the tool holder 62 to the land preparation tool 66.

As stated above, the respective channels of the land preparation tool 66 and the tool holder 62 may comprise internal threads. These internal threads may be used to engage external threads (not shown) of the securing bolts 90. As shown in FIG. 3B, a locking washer 92, locking pin or other suitable mechanism may be used to ensure the securing bolt(s) 90 is firmly secure within the channels of the land preparation tool 66, and the tool holder 62. For additional details regarding the bolt securing mechanism, U.S. Publication No. 2009/0014189 A1 is incorporated by reference herein in its entirety.

Referring again to FIG. 3B, the inverse mounting surfaces 64 and 68 of the tool holder 62 and land preparation tool 66, respectively, yield many unique advantages to the land preparation machine 10. For example, the V-shape non-planar profiles of inverse mounting surfaces 64 and 68 provides a locking advantage by ensuring that all forces are driven to the center of the tool holder. This increased contact area, along with the V-shaped profile reduces the opportunity for the bolting system to loosen during vibration and shock loading. The vertical direction of the V-shape profile allows for symmetrical tools that can be flipped to utilize a double-ended tool design. The locking advantage that the V-shape design provides greatly reduces the risk of the tool rotating or twisting the mounting joint with impacted compared to alternative designs. Along with these advantages, the V-shaped tool profile allows for lower cost manufacturing. The increase surface area along with the V-shape profile allows for manufacturing variations as well as the performance benefits provided by the larger supporting surface area.

Referring to the embodiments of FIGS. 9A and 9B, the tool assemblies 60 may also comprise intermediate connectors disposed 76 between the tool holder 62 and the land preparation tool 66 and configured to couple the tool holder 62 and the land preparation tool 66. Due to wear and tear on the tool assemblies 60 from the rotation of the drum 52 and the mulching action performed, it has been found beneficial to have an intermediate connector 76, which may be easily removed and replaced. While various materials are suitable, it is contemplated that the intermediate connector 76 may comprise a different material than the land preparation tool 66 or the tool holder 62. The intermediate connector 76 may comprise carbide, mild steel, or other materials, such as metals, and durable organic and inorganic compositions as would be familiar to one of ordinary skill in the art. The intermediate connectors 76 may also have varying shapes and dimensions. In operation, the intermediate connector 76 is operable to join the land preparation tool 66 and the tool holder 62 by press fitting, slip fitting, etc.

While optional, the intermediate connector 76 provides numerous benefits to this land preparation apparatus 14. For example, the intermediate connector 76 protects against tool holder 62 wear, while acting as a structural support for tool positioning and lateral loading. The intermediate connector 76 may also improve fastening between the tool holder 62 and land preparation tool 66. As stated above, the intermediate connector 76 has a unique design and removability that enables it to be manufactured out of materials different from the tool holder 62 or land preparation tool 66. By altering the material properties of the intermediate connector 76 material, component wear can be controlled and an increased level of tolerance may be provided with minimal cost to the system.

Referring again to FIGS. 9A and 9B, the intermediate connector 76 may comprise a tool holder interface 78, which is a surface configured to be in flush contact with the mounting surface 64 of the tool holder 62, thereby forming a friction of interference fit. The tool holder interface 78 defines a non-planar profile inverse to the non-planar profile of the tool holder mounting surface 64. Like above, the non-planar profile defines any surface, which is not a straight planar surface. Illustrations of a non-planar profile may include V-shaped, concave, or convex profiles, or combinations thereof. As shown in FIGS. 9A and 9B, the tool holder interface 78 may comprise a V-shaped concave profile, which is an inverse shape of the V-shaped convex profile of the tool holder 62, and thereby facilitates mating of the tool holder interface 78 and the tool holder mounting surface 64.

Referring again to FIGS. 9A and 9B, the intermediate connector 76 also includes a tool interface 85 disposed on a surface of the intermediate connector 76 opposite the tool holder interface 78. The tool interface 85 may be configured to contact the mounting surface 268 of the land preparation tool 66. Although FIGS. 9A and 9B depict the mounting surface 268 as a flat planar profile, it is contemplated that the mounting surface 268 could include a non-planar profile, such as the V-shaped profile or the other non-planar profiles described in detail above. It is further contemplated that the tool interface 85 and the tool mounting surface 268 may define inverse surfaces, configured to form an interference fit.

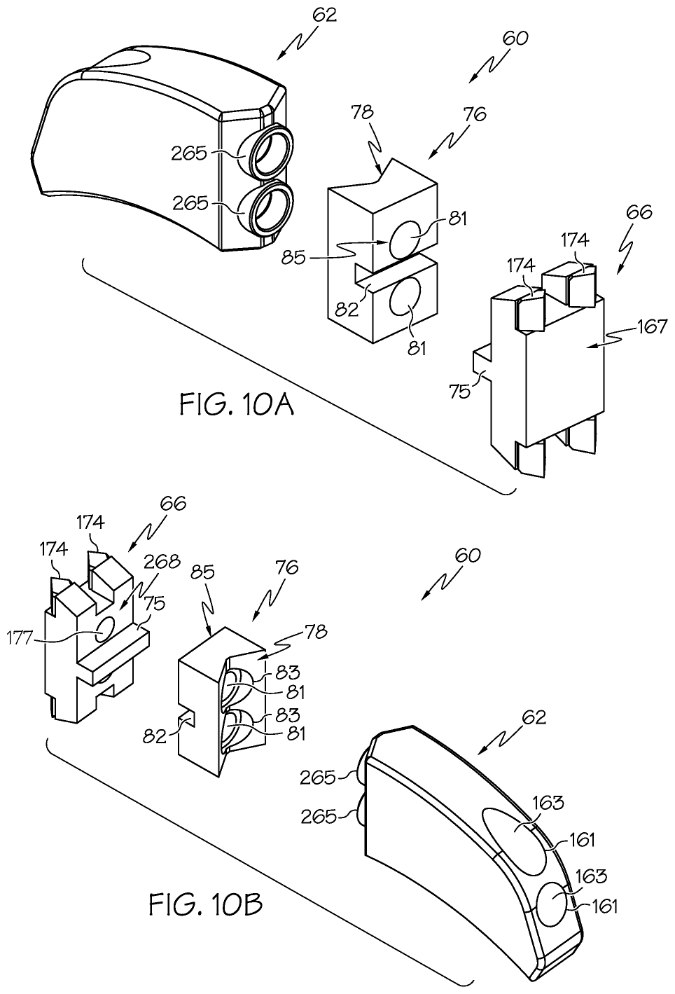

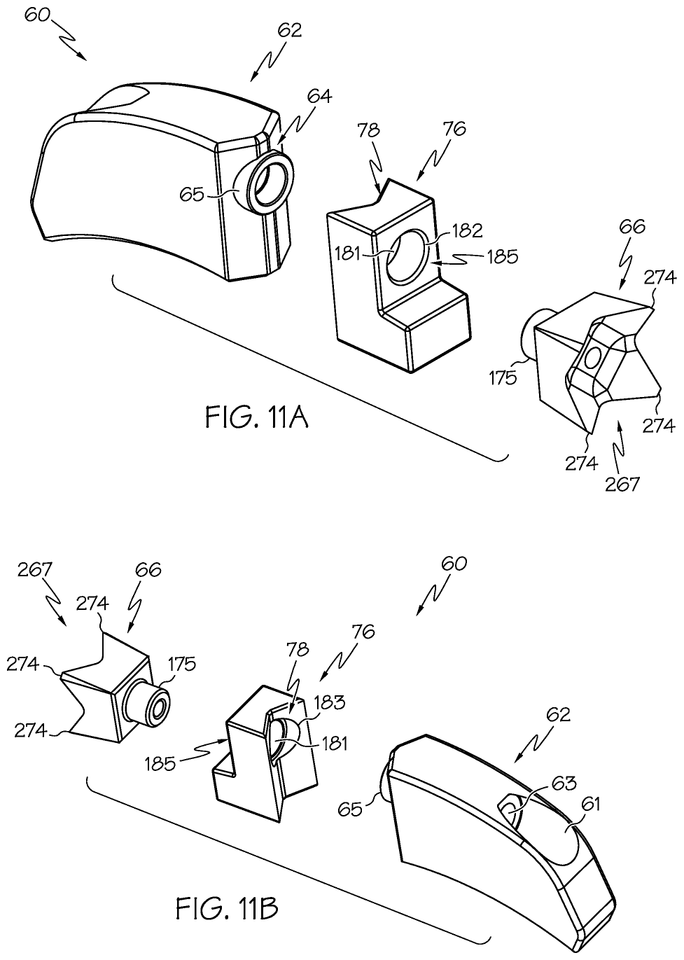

To provide additional securing of tool assembly 60 components, additional coupling components may be utilized. Referring to FIGS. 10A and 10B, the tool holder interface 78 may comprise a coupling mechanism configured to matingly connect with a coupling mechanism (e.g., a pair of rounded pegs 265 as in FIG. 10A) of the tool holder 62. In the embodiment of FIGS. 10A and 10B, the coupling mechanism of the tool holder interface 78 may comprise two round recesses 83 operable to matingly receive the rounded pegs 265 of the tool holder 62. In the alternative embodiment of FIGS. 11A and 11B, the coupling mechanism of the tool holder interface 78 may comprise one round recess 183 operable to matingly receive a rounded peg 65 of the tool holder 62. The reverse configuration wherein the tool holder interface 78 comprises at least one round peg and the tool holder mounting surface 64 comprises at least one rounded recess is further contemplated herein.

Moreover, each tool interface 85 may comprise a coupling mechanism operable to matingly connect with a coupling mechanism of the land preparation tool 66. As shown in the embodiment of FIGS. 10A and 10B, the coupling mechanism of the tool interface 85 may comprise at least one rectangular recess 82 and the coupling mechanism of the land preparation tool 66 comprises at least one rectangular peg 75 matingly inserted into the rectangular recess 82 of the tool interface 85. In an alternative embodiment as shown in FIGS. 11A and 11B, the coupling mechanism of the tool interface 85 may comprise one round recess 182 operable to matingly receive a rounded peg 175 of the land preparation tool 66. Although the figures only depict one rectangular or round peg and one corresponding rectangular recess or rounded recess, respectively, it is contemplated that the mating arrangement may include more than one peg/recess or a combination of rectangular and round peg/recesses. Like above, the reverse configuration wherein the tool interface 85 comprises at least one rectangular peg and the tool holder comprises at least one rectangular recess is further contemplated herein.

As described above, the attachment of the tool holder 62 to the land preparation tool 66 may further include an additional securing mechanism, for example, via bolts 90 as shown in FIG. 3B. Similarly, the additional securing mechanism may also be incorporated into the tool assemblies 60 which include am intermediate connector 76, for example, the tool assembly 60 embodiments of FIGS. 9A-11B. As shown in FIG. 9A, the intermediate connector 76 may comprise at least one channel 81 extending from the tool holder interface 78 to the tool interface 85, wherein the channels 81 are configured to align with the channels 161 of the tool holder 62 and the channels 177 of the land preparation tool 66. Similar to the bolting arrangement of FIG. 3B, the bolt(s) 90 would be secured through the aligned channels of the tool holder 62, the intermediate connector 76, and the land preparation tool 66. In contrast to the double channel 81 embodiments of FIGS. 9A-10B, it is further contemplated that single channels 181 may also be used, as shown in FIGS. 11A and 11B. Further similar to the bolting arrangement of FIG. 3B, the channels 81 or 181 may include internal threads (not shown) to engage the external threads (not shown) of the bolt 90.

When assembling the land preparation apparatus 14 as shown in FIGS. 3A and 3B, the tool holder 62 is mounted to a drum 52 by a suitable mounting mechanism, for example, through a bolt, screw, or weld. To couple the land preparation tool 66 to the tool holder 62, the inverse mounting surfaces 64 and 68 contact one another, thereby forming an interference or friction fit. Additionally, the round peg 65 of the tool holder 62 may be matingly inserted into the recessed region 73 of the land preparation tool 66 to additionally secure the tool assembly 60. Moreover, bolt(s) 90 may be inserted through the channels of the tool holder 62, and land preparation tool 66 to further secure the tool assembly 60.

Alternatively, as shown in the embodiment of FIGS. 10A and 10B, the intermediate connector 76 may be utilized in the tool assembly 60 when assembling the land preparation apparatus 14. First, the tool holder interface 78 of the intermediate connector 76 and the mounting surface 64 of the tool holder 62, which define inverse non-planar surface profiles, contact one another, thereby forming an interference or friction fit. Further as shown in the embodiment of FIG. 10A, the rounded pegs 165 of the tool holder 62 may be matingly inserted into the rounded recesses 83 of the intermediate connector 76. Then, the rectangular peg 75 of the land preparation tool 66 may be matingly inserted into the recessed region 82 of the intermediate connector 76. At which point, the intermediate connector 76 resides within the land preparation tool 66 and the tool holder 62. Additionally, a bolt(s) 90 may be inserted through the channels of the tool holder 62, the intermediate connector 76, and the land preparation tool 66 to further secure the tool assembly 60.

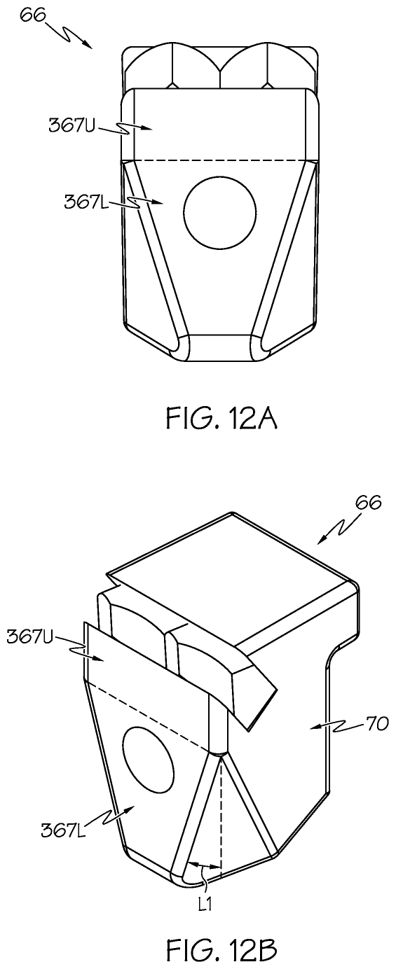

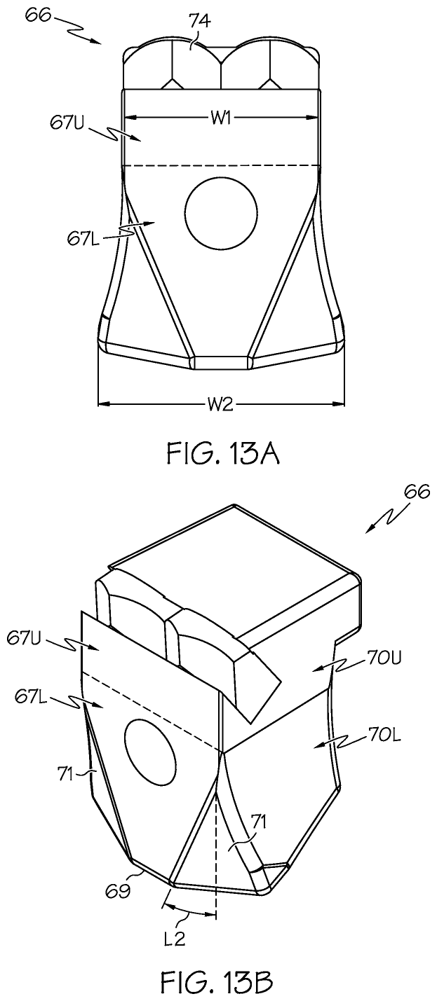

In addition to the improved coupling of the components of the tool assembly 60, other embodiments are directed to improvements in the land preparation tool 66, specifically with regard to the cutting surface 67 disposed on a surface opposite the mounting surface 68 of the land preparation tool 66. As shown in FIGS. 13A and 13B, the cutting surface 67 (as shown in FIGS. 4A-6B) may define an upper region 67U and a lower region 67L. The lower region 67L defines a non-planar profile extending outwardly from a plane defined by the upper region 67U. The non-planar lower region 67L of the cutting surface may inwardly taper from a pair of opposite edges toward a midpoint of the cutting surface, or outwardly taper from a pair of opposite edges toward a midpoint of the cutting surface. Additionally, the non-planar profile may be a V-shaped outwardly extending profile as shown in FIGS. 12A-13B, a convex profile, a concave profile, a trapezoidal profile or another suitable profile familiar to one of ordinary skill in the art. Due to this non-planar profile, the lower region 67L may define a non-planar profile extending outwardly a distance L2 from a plane defined by the upper region 67U as shown in FIGS. 13A and 13B. Moreover, the lower region 67L may extend widthwise (W2) a horizontal distance which is greater than the width (W1) of the upper region 67U. Moreover, as shown in FIGS. 13A and 13B, the land preparation tool 66 may comprise a pair of side surfaces 70 extending between the mounting surface 68 and the cutting surface 67, wherein the side surfaces 70 comprise an upper region 70U and a lower region 70L. In conjunction with the lower region 67L of the cutting surface, the lower region 70L may also extend widthwise a horizontal distance greater than the width (W1) of the upper region 67U of the cutting surface. As shown in an alternative embodiment on FIGS. 12A and 12B, the non-planar lower region 367L may define a non-planar profile extending outwardly a distance L1 from a plane defined by the upper region 367U; however, the lower region 367L does not extend widthwise a horizontal distance, which is greater than the width of the upper region 67U.

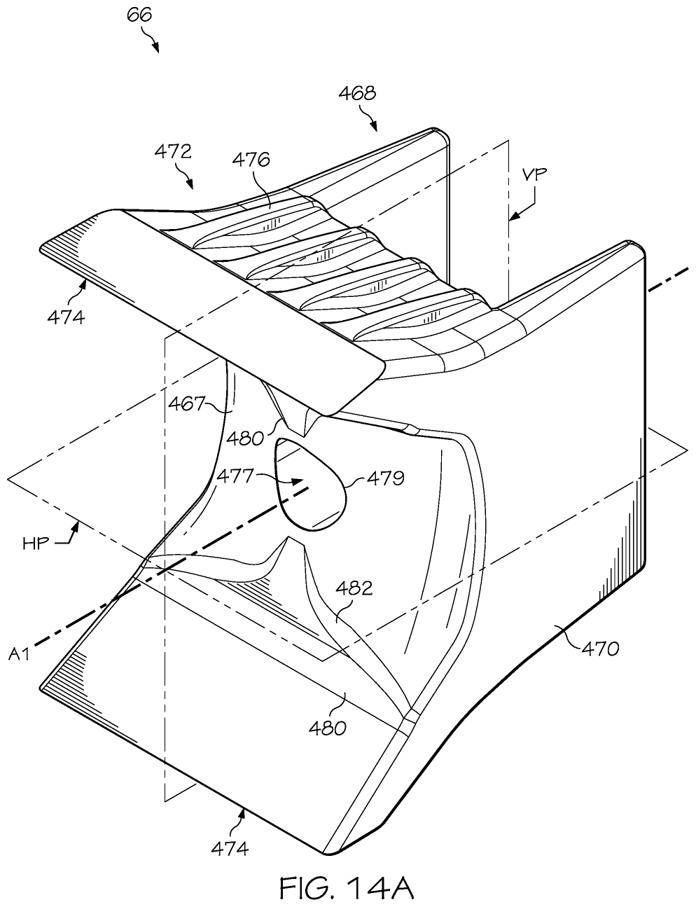

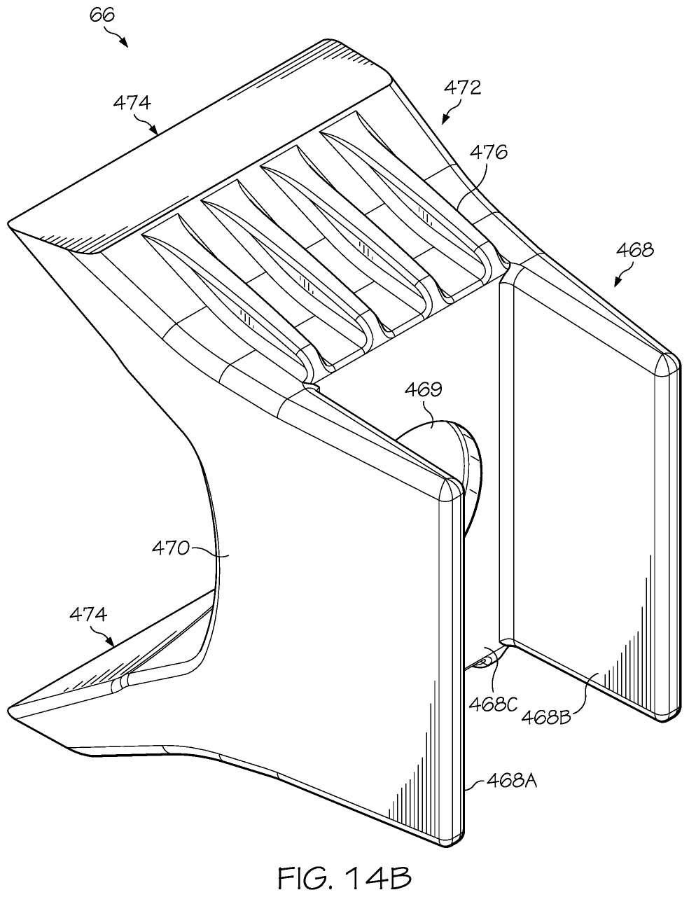

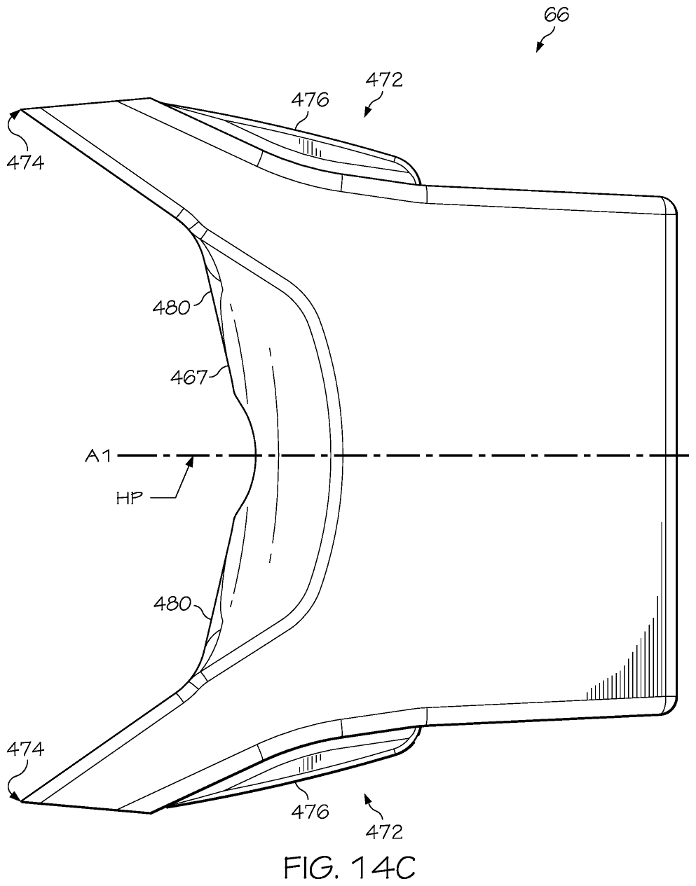

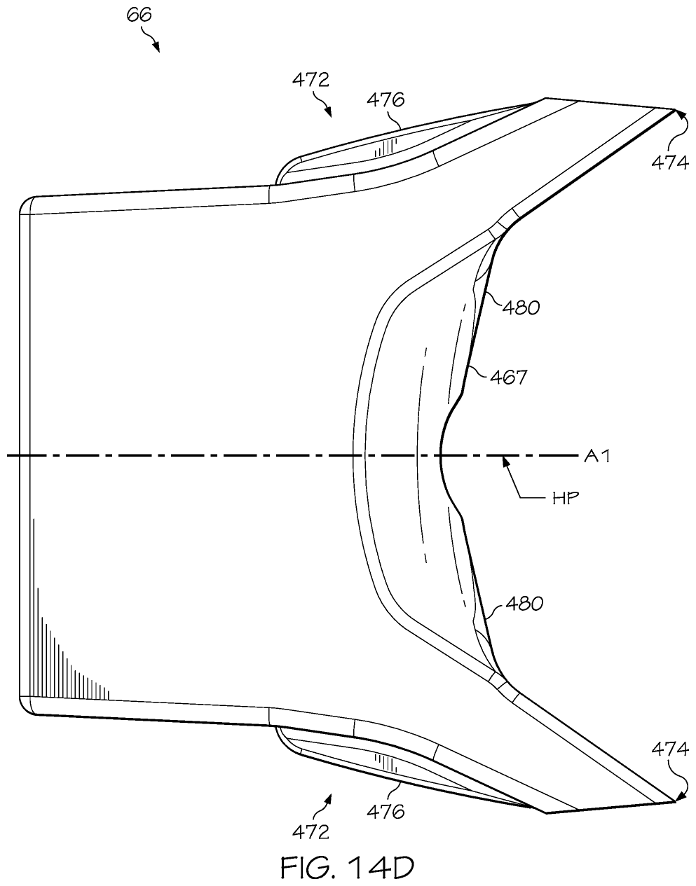

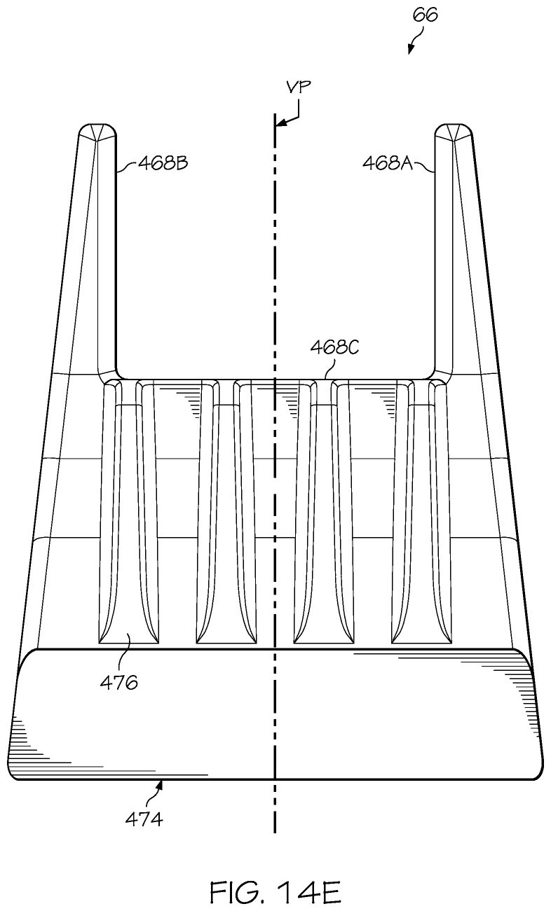

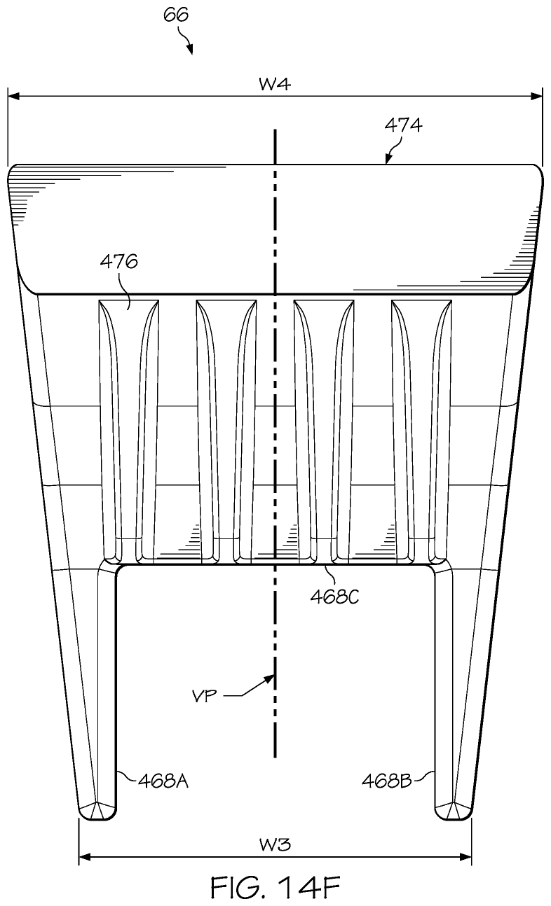

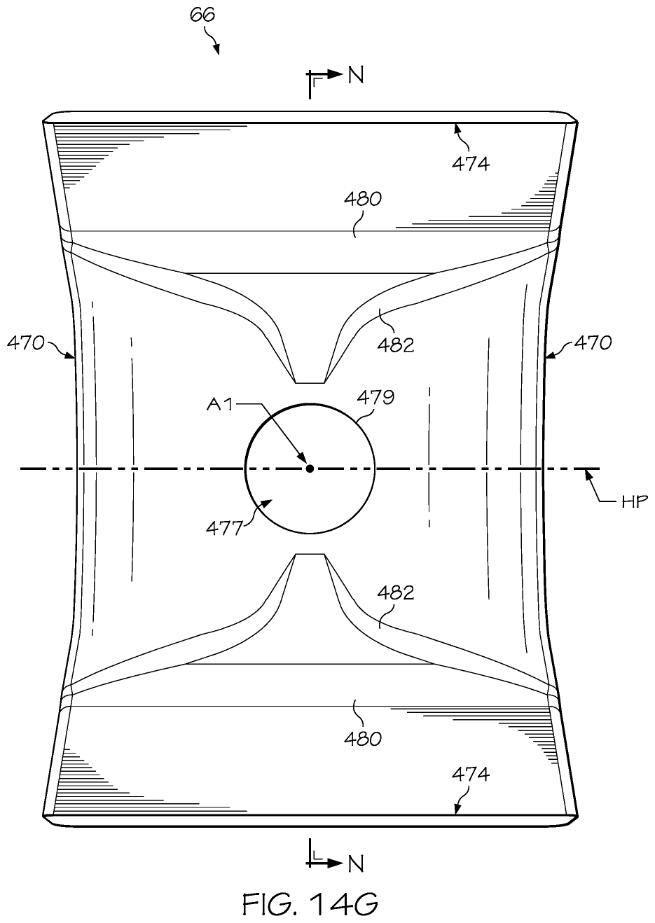

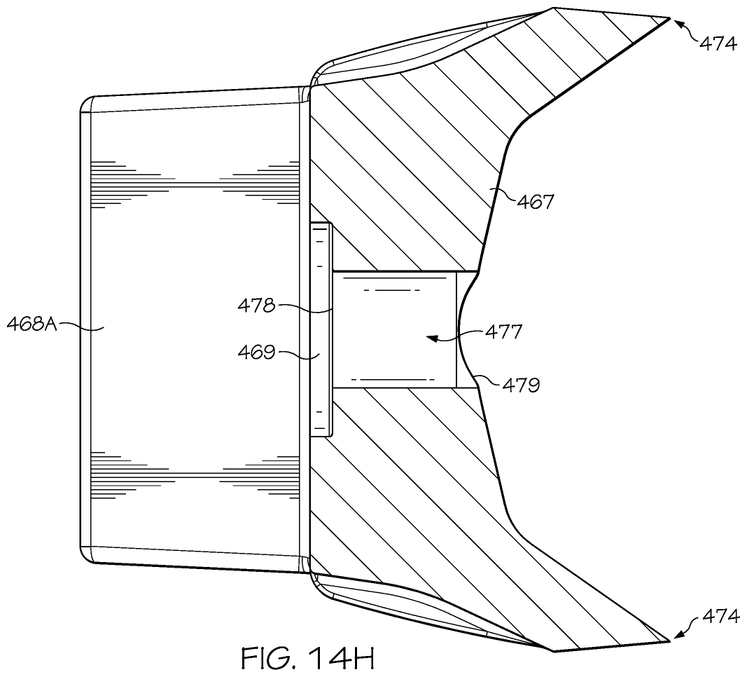

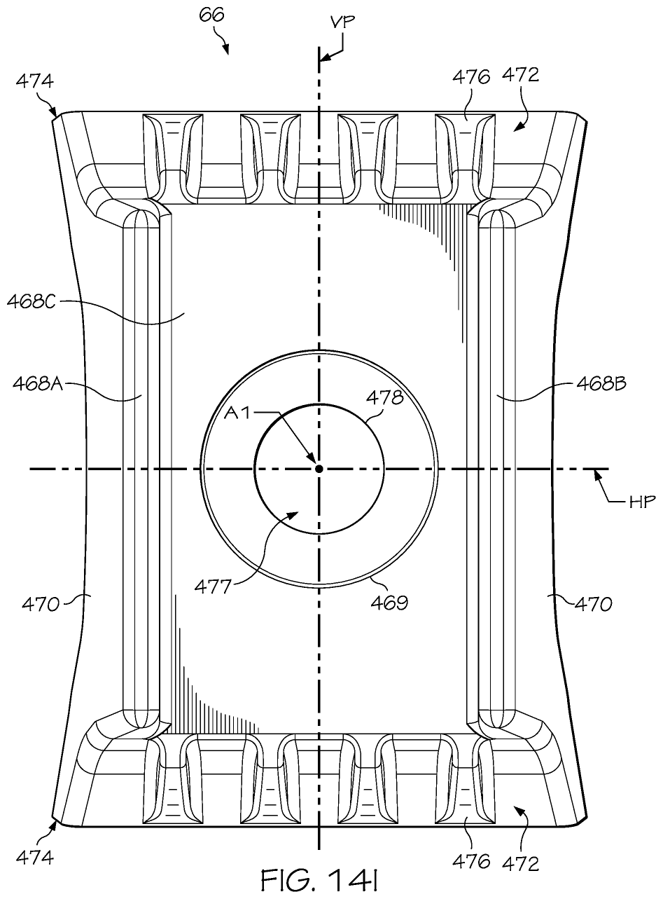

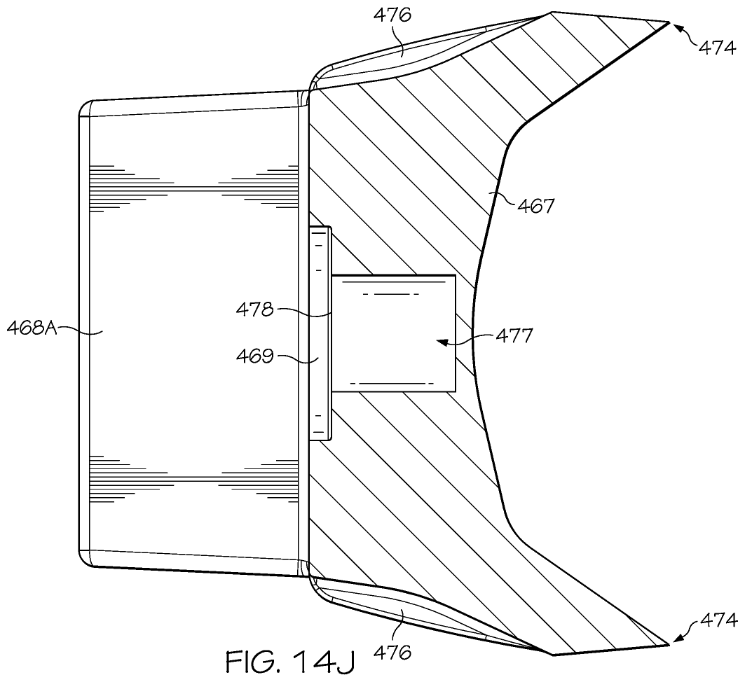

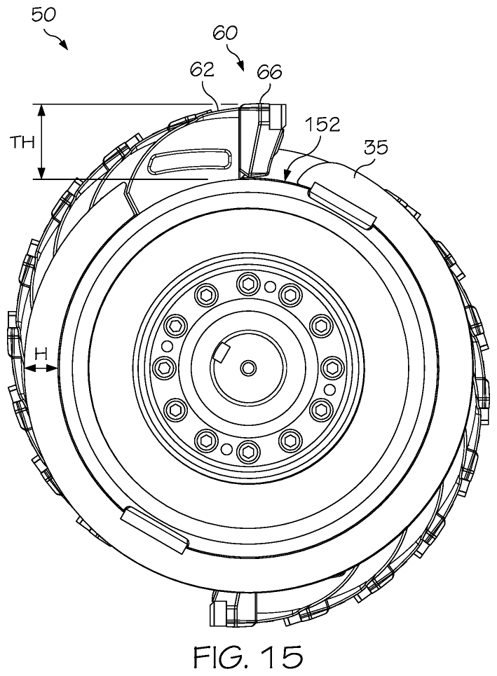

An illustrative embodiment of a land preparation tool 66 is shown in FIGS. 14A-14I. Although not shown in FIGS. 14A-14I, the land preparation tool 66 shown can form a part of and be connected to a tool assembly 60 by a tool holder 62, and optionally, an intermediate connector 76, as discussed above. The tool assembly 60 can be connected to a rotary drum 52, as depicted in FIG. 3B. In an illustrative embodiment, the land preparation tool 66 can be considered symmetric about two imaginary planes, a first plane such as, for example, a horizontal plane HP and a second plane such as, for example, a vertical plane VP, which can intersect at a line defining longitudinal axis A1. In some embodiments, longitudinal axis A1 may be the central axis of the tool 66. Longitudinal axis A1 can correspond to the bolt axis described above, particularly with respect to FIG. 3B. As used herein, the terms “vertical” and “horizontal” are used with respect to the orientation of FIGS. 14A-14I, and relate to an in-use configuration of the land preparation tool 66.

The land preparation tool 66 can comprise a cutting surface 467 defining a non-planar, concave surface, as viewed parallel to and level with the imaginary horizontal plane HP, as shown in FIG. 14C. In general, the cutting surface 467 need not be symmetrical about the imaginary horizontal plane HP, and can, for example, have a cutting blade 474 as described herein on one side only of the imaginary horizontal plane HP (e.g., on only an upper portion of the land preparation tool 66). The cutting surface 467 may be U-shaped and include two cutting blades 474 disposed on opposite sides or ends of the cutting surface 467 (or, for example, on opposite ends of the tool 66). The cutting blade(s) 474 can be relatively sharp edges at the extremity of the U-shaped cutting surface 467, disposed distally and generally parallel to imaginary horizontal plane HP. The cutting blade(s) 474 can be tapered distal edge(s) of the cutting surface. The tapered distal edge(s) of cutting blade(s) 474 can be tapered to a blade-like edge. In the illustrated embodiment, having two cutting blades 474 disposed oppositely in the vertical plane VP permits, as discussed above, the land preparation tool 66 to be flipped thereby allowing both blades to be utilized for longer tool life. That is, as one blade wears during use, the land preparation tool 66 can be removed, inverted, reinstalled, and the second blade can be used. In general, the concave profile of the cutting surface 467 may be a V-shaped outwardly extending profile, a convex profile, a non-planar profile, a trapezoidal profile, or another suitable profile familiar to one of ordinary skill in the art.

As shown in 14A-14I, the land preparation tool 66 may comprise a pair of side surfaces 470 extending between a mounting interface 468 and the cutting surface 467, the side surfaces 470 may taper inward toward the second, vertical plane VP, in a top view as shown in FIG. 14E. The land preparation tool 66 may also comprise a pair of upper and lower surfaces 472 extending between the mounting interface 468 and the cutting surface 467. The upper and lower surfaces 472 may include a series of ridges 476. Ridges 476 can be generally linearly oriented and aligned directionally with axis A1 in a spaced, parallel relationship. Ridges 476 can be raised ribs. In some embodiments, the upper and lower surfaces 472 may include a series of channels, instead of the ridges 476. The channels can be indentations lowered from the upper and lower surfaces 472. In some embodiments, the upper and lower surfaces may comprise both a plurality of ridges and channels.

The mounting interface 468 is configured to interface with a tool holder mounting surface of a tool holder, e.g., the tool holder mounting surface 64 or the tool holder mounting surface 164 of the tool holder 62, or any other suitably configured mounting surface of a tool holder. As shown in the illustrative embodiment of FIGS. 14A-14I, the mounting interface 468 includes first and second sidewalls 468A, 468B extending outwardly from a base 468C. The first and second sidewalls 468A can be substantially planar in a parallel or diverging near-parallel relationship relative to one another. The base 468C can be substantially planar and generally perpendicular or near-perpendicular to the first and second sidewalls 468A, 468B and include an opening 478 disposed thereon. In some embodiments, the base 468C of the mounting interface 468 can define a rounded recess 469. In such embodiments, the opening 478 may be disposed within the rounded recess 469. When viewed from a plan view, such as the one illustrated in FIG. 14E, the first sidewall 468A, second sidewall 468B, and base 468C of the mounting interface 468 define a substantially concave or U-shaped structure that opens in a direction opposite to the direction in which the cutting surface 467 opens. For example, as shown in the illustrative embodiment of FIGS. 14A-14I, the mounting interface 468 can define a substantially “square” U-shaped structure in which the sidewalls 468A, 468B, or at least the respective inner surfaces of the sidewalls 468A, 468B, are substantially parallel relative to one another.

At least one channel 477 can extend into the land preparation tool 66 from the opening 478 disposed on the base 468C of the mounting interface 468 to facilitate access for a mounting or securing bolt (not shown). As illustratively shown in FIG. 14H, the channel 477 can extend from the opening 478 disposed on the base 468C to an opening 479 disposed on the cutting surface 467. In alternative embodiments of the land preparation tool 66, such as the one illustratively shown in FIG. 14J, the channel 477 may extend only partially into the body of the land preparation tool 66 from the opening 478. For example, in such embodiments, the channel 477 may be a blind bore having internal threads to which a mounting bolt can be threaded. The vertical configuration of the U-shape in the profile allows for symmetrical tools that can be flipped to utilize a two-sided tool design. As a result of the inverse non-planar profiles of the mounting surfaces, flush contact may be achieved when the tool holder 62 and land preparation tool 66 are connected. This can yield an interference fit or a friction fit between the inverse surfaces 64 and 68, which combats sliding (e.g., horizontal sliding) of the tool holder 62 or land preparation tool 66.

Referring back to FIGS. 14A-14I, the land preparation tool 66 can have one or two shaped flow diverting surfaces 480 disposed on cutting surface 467. Two flow diverting surfaces 480 can be disposed opposite one another and can be substantially mirror images symmetrically disposed one either sides of horizontal plane HP. Flow diverting surfaces 480 can be shaped to relatively smoothly divert material away from a central portion near opening 479 and toward the side portions of the cutting surface 467, and ultimately away from land preparation tool 66, when the land preparation tool 66 is in use. As shown in FIGS. 14A and 14G, each of the flow diverting surfaces 480 can be a raised, shaped ridge-like surface having a central proximal portion disposed relatively near horizontal plane HP, and a shaped edge 482 diverging away from the proximal portion to distal portions near the sides 470 and relatively distant from horizontal plane HP. Each flow-diverting surface can be described as a portion of the cutting surface that comprises an angled surface that sweeps backward from the cutting surface toward the mounting interface.

The land preparation tool 66 can have a tapered profile, as depicted in FIGS. 14E-14F. As shown, when viewed from the bottom (FIG. 14F) or top, the land preparation tool 66 can have a relatively narrower width W3 measured to the outside surfaces at the rear, mounting portion, of the tool 66, compared to a relatively greater width W4 measured to the outside surfaces at the front, cutting portion, of the tool 66. As can be understood, in an embodiment, the external tapering of the outside surfaces of the sidewalls 468A, 468B can be contrasted with the substantially parallel relationship of the inside surfaces of the sidewalls 468A, 468B.

The land preparation tools 66 shown in FIGS. 14A-14J can be connected to a rotatable tool 50 comprising a rotatable drum 52 or rod and a plurality of tool assemblies 60, as discussed above, particularly with respect to FIG. 3B. In an embodiment, the land preparation tools 66 shown in in FIGS. 14A-14J can be connected to a rotatable tool 50, as shown in FIG. 15, described more fully below. In some embodiments, a tool assembly 60 may include a tool holder 62, and the tool holder 62 may include a bushing or peg (not shown) as discussed above with respect to FIGS. 4A and 4B. Likewise, in some embodiments, the bushing or rounded peg of the tool holder 62 may be matingly inserted into the rounded recess 469 of the land preparation tool 66. As discussed above, the tool holder 62 and the land preparation tool 66, as well as any optional intermediate connector 76 utilized, can be secured by one or more securing bolts 90. For example, in an embodiment, such as the one as shown in FIG. 14H, the channel 477 can be a through-hole, and a securing bolt (not shown) can extend through both the tool holder 62 and the land preparation tool 66 and secure, for example, the land preparation tool 66 to the tool holder 62 with a nut, a locking nut, a nut and washer combination, and the like. In another embodiment, such as the one shown in FIG. 14J, the channel 477 can be a blind bore comprising internal threads to which a securing bolt (not shown) can be threaded. For example, a securing bolt can extend through a tool holder 62 and be threaded into the channel 477 through mounting interface 468. In some embodiments, the tool holder 62 may not include the bushing or rounded peg and the land preparation tool 66 may also not include the rounded recess 469

FIG. 15 shows an illustrative embodiment of a rotatable tool 50 comprising a rotatable drum 152 or rod and a plurality of tool assemblies 60 spaced along, attached to, and extending radially from the tool drum 152. The rotatable drum 152 includes a plurality of depth control rings 35 that may be attached to and extend from the drum 152. The tool holder 62 of each tool assembly 60 may be coupled to the depth control ring 35. Each tool assembly 60 may also include a fastening device that detachably connects the cutting tool 66 to the tool holder 62. An inner diameter of the depth control ring 35 may be disposed about the outer drum shell. In some embodiments, the depth control ring 35 is fixedly coupled (e.g., welded, epoxied, screwed, bolted, braised, bonded, etc.) to the outer drum shell. In other embodiments, the depth control ring 35 is detachably coupled to the outer drum shell through conventional and/or yet-to-be developed mechanisms. In either case, the depth control ring 35 extends radially from the outer drum shell at a depth height (H). The depth height (H) of the depth control ring 35 may be varied to provide a desired distance between an maximum radial dimension of the land preparation tool 66 and a peripheral edge of the depth control ring 35 and/or the surface of the outer drum shell. In the illustrative embodiment, the depth height (H) of the depth control ring 35 is less than the overall height TH of the tool assembly 60. For example, in some embodiments, the depth height (H) of the depth control ring 35 is less than or equal to half of the overall height of the tool assembly 60 when installed. In some embodiments, the depth height (H) of the depth control ring 35 can be about 20% to about 80%, or about 30% to about 60% of the overall height TH of the tool assembly 60 when installed. It should be appreciated, however, that the depth height (H) of the depth control ring 35 can be less than, greater than, or equal to any other partial height of the tool assembly 60 when installed. For additional details regarding depth control rings on a rotatable drum, U.S. Publication No. 2017/0079219 A1 has been incorporated by reference herein in its entirety. It should also be appreciated that any of the tools 66 (e.g., the tool 66 depicted in FIGS. 14A-14I, the alternative tool 66 depicted in FIG. 14J, etc.) can be configured to interface with the tool holder 62 (e.g., the tool holder 62 depicted in FIGS. 4A-4B and FIGS. 6A-6B, FIG. 15, etc.).

It is noted that terms like “specifically,” “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A land preparation tool comprising:
a tool body having a longitudinal axis, the tool body comprising a first imaginary plane and a second imaginary plane, the first and second imaginary planes intersecting orthogonally at the longitudinal axis, wherein the tool body comprises:
a cutting surface, the cutting surface comprising a first concave surface, the first concave surface being symmetric about the first imaginary plane and comprising a first cutting blade at a first distal end and a second cutting blade at a second distal end;
a mounting interface disposed on the tool body opposite the cutting surface, the mounting interface comprising a second concave surface being symmetric about the second imaginary plane; and
the tool body defining a channel extending into the tool body.

2. The land preparation tool according to claim 1, wherein the second concave surface of the mounting interface comprises a concave surface selected from the group consisting of U-shaped, V-shaped, and combinations thereof.

3. The land preparation tool according to claim 1, wherein the second concave surface of the mounting interface comprises a first side surface, a second side surface in separated, parallel relationship to the first side surface, the first and second side surfaces being connected by a base surface.

4. The land preparation tool according to claim 1, wherein the cutting surface further comprises a first tapered distal edge defining the first cutting blade, and a second tapered distal edge defining the second cutting blade, the first and second cutting blades being parallel to the first imaginary plane.

5. The land preparation tool according to claim 1, further comprising an upper surface and a lower surface, the upper and lower surfaces each extending between the mounting interface and the cutting surface.

6. The land preparation tool according to claim 1, further comprising an upper surface and a lower surface, the upper and lower surfaces each extending between the mounting interface and the cutting surface and each of the upper and lower surfaces comprising a plurality of ridges linearly oriented and aligned with the longitudinal axis in a parallel, spaced relationship.

7. The land preparation tool according to claim 1, wherein the channel extends entirely through the tool body and the cutting surface.

8. The land preparation tool according to claim 1, wherein:
a portion of the cutting surface comprises a first flow diverting surface comprising a first angled surface that sweeps backward from the cutting surface toward the mounting interface; and
a second portion of the cutting surface comprises a second flow-diverting surface comprising a second angled surface disposed on a side of the cutting surface opposite the first angled surface, the second angled surface sweeps backward from the cutting surface toward the mounting interface.

9. The land preparation tool according to claim 8, wherein the tool body comprises a rear portion having a width W3 and a front portion having a width W4, wherein W4 is greater than W3.

10. The land preparation tool according to claim 1, wherein the channel comprises a blind bore having internal threads.

11. A land preparation tool comprising:
a tool body having a longitudinal axis, the tool body comprising a first imaginary plane and a second imaginary plane, the first and second imaginary planes intersecting orthogonally at the longitudinal axis, wherein the tool body comprises:
a concave cutting surface, the cutting surface comprising a blade;
a mounting interface disposed on the tool body opposite the cutting surface, wherein the mounting interface comprises a non-planar profile selected from the group consisting of concave, U-shaped, and combinations thereof; and
the tool body defining a channel extending through the tool body.

12. The land preparation tool according to claim 11, wherein the cutting surface is symmetric about the first imaginary plane and the blade is disposed at a first distal end of the cutting surface.

13. The land preparation tool according to claim 12, wherein the cutting surface comprises two blades.

14. A land preparation apparatus, comprising:
a rotatable drum;
a plurality of tool holders arranged on the drum, wherein each tool holder comprises a connection interface;
a plurality of land preparation tools, wherein each land preparation tool is configured to connect with a tool holder of the plurality of tool holders and wherein at least one land preparation tool comprises a tool body having a longitudinal axis, the tool body comprising a first imaginary plane and a second imaginary plane, the first and second imaginary planes intersecting orthogonally along the longitudinal axis, wherein the tool body comprises:
a cutting surface, the cutting surface comprising a first concave surface, the first concave surface being symmetric about the first imaginary plane and comprising a first cutting blade at a first distal end and a second cutting blade at a second distal end;
a mounting interface disposed on the tool body opposite the cutting surface, the mounting interface comprising a second concave surface being symmetric about the second imaginary plane; and
the tool body defining a channel extending into the tool body.

15. The land preparation apparatus according to claim 14, wherein the channel comprises a blind bore having internal threads.

16. The land preparation apparatus according to claim 14, wherein the second concave surface of the mounting interface comprises comprising a first side surface and a second side surface, the first and second side surfaces being connected by a base surface.

17. The land preparation apparatus according to claim 14, wherein the cutting surface further comprises a first tapered distal edge defining the first cutting blade, and a second tapered distal edge defining the second cutting blade, the first and second cutting blades being parallel to the first imaginary plane.

18. The land preparation apparatus according to claim 14, wherein the land preparation tool further comprises an upper surface and a lower surface, the upper and lower surfaces each extending between the mounting interface and the cutting surface.

19. The land preparation apparatus according to claim 18, wherein each of the upper and lower surfaces includes a plurality of ridges linearly oriented and aligned with the longitudinal axis.

20. The land preparation tool according to claim 14, wherein the channel extends entirely through the tool body and the cutting surface.
